(19) United States
(12) Patent Application Publication
(10) Pub. No.: US 2006/0289392 A1
(43) Pub. Date: Dec. 28, 2006

(54) Method and Apparatus for Clamping an Electrode Tube in EDM Drill Equipment

(75) Inventor: Tong-Han Lin, Shinying City (TW)

Correspondence Address: WPAT, PC;INTELLECTUAL PROPRTY ATTORNEYS, 2030 MAIN STREET, SUITE 1300, IRVINE, CA, 92614, US

(73) Assignee: TAI-I ELECTRON MACHINING CO., LTD., Shinying City (TW)

(21) Appl. No.: 11/425,388

(22) Filed: Jun. 20, 2006

(30) Foreign Application Priority Data
Jun. 24, 2005 (TW) 094121068

(51) Int. Cl. B23H 7/26

(52) U.S. Cl. 219/69.15

(57) ABSTRACT

A method and apparatus for clamping an electrode tube in an EDM drill equipment is incorporated with an elastic seal and a collet. The method providing an insert having a through hole disposed at the center to concentrically accommodate and restrict the elastic seal, placing the insert into the collet, and inserting the electrode tube in the insert and the elastic seal, tightening the nut to the spindle to clamp the electrode tube and passing the EDM machining current from the spindle to electrode tube. The apparatus includes an insert having a retaining ring to restrict an elastic seal, a through hole to admit insertion by the electrode tube. The insert of the above method and apparatus comprises a guiding pipe to be secured in the collet, and a tapered guide hole interconnecting with the through hole to facilitate insertion of the electrode tube. Optional slots are provided at the lower portion of the guiding pipe.

### BACKGROUND OF THE INVENTION

(a) Field of the Invention

The present invention relates to a method and apparatus for clamping an electrode tube in EDM drill equipment, and more particularly, to one has an insert to restrict an elastic seal and the electrode tube with the elastic seal being located in the center of a collet nut system.

(b) Description of the Prior Art

Whereas in EDM drilling process with a pressurized dielectric fluid (up to 1500 psi or higher) ejected from soft electrode tube with diameter range from 0.1 mm to 7 mm, the prior art of clamping method that using collet nut system meets its limitation in sealing high pressure fluid, and in clamping small diameter electrode tube that is not greater than 0.3 mm in diameter. However, as illustrated in FIG. 8 of the accompanying drawings, the electrode tube (B) is clamped in the EDM drilling process of the prior art by having the upper end of an electrode tube (B) to directly insert through a resilient leak-proof seal (A). The leak-proof seal (A) is further placed on a collet (C) in a shape of a claw for being cut with multiple flutes. Both the collet (C) and the leak-proof seal (A) are accommodated in a spindle (D). A nut (D1) is mounted to the lower end of the spindle (D) for the collet (C) to clamp the electrode tube (B). The leak-proof seal (A) in the upper end of the collet (C) is compressed to hold tightly against the spindle (D) to seal up where between the inner side of the spindle (D) and the outer side of the electrode tube (B) for leak-proof purposes.

Since the pressure of the dielectric fluid passing through the electrode tube (B) is extremely high (up to 1500 psi or higher), the force from the spindle (D) and the collet (C) compressing against the leak-proof seal (A) must be relatively greater even by fold than the pressure of the dielectric fluid to prevent leak. Accordingly, the prior art is found with the following shortcomings:
1. Leak-proof seal not durable: whereas the upper end of the collet (C) is recessed or hollowed, the bottom of the leak-proof seal (A) for being subject to the force would have to sink into the flute and the recessed or hollowed space at the top of the collet (C), resulting in permanent deformation of the bottom and expansion (enlarged diameter) of the leak-proof seal (A). Accordingly, the leak-proof seal (A) has to be waived after use for a couple of times [2-3 times] or replaced even in its initial mounting when failing the leak-proof purposes.
2. Electrode tube vulnerable to deformation: to stop leakage, the force of compression against the leak-proof seal (A) has to be extremely high; permanent deformation of the leak-proof seal (A) in turn is subject to even greater compression than ever and further permanent deformation. In such a detrimental cycle, the leak-proof seal (A) is soonest waived. The deformed leak-proof seal (A) also presses against the electrode tube (B) to damage the electrode tube (B) particularly when the diameter of electrode tube (B) is not greater than 0.3 mm.
3. Electrode tube vulnerable to be deflected and crashed:

whereas the leak-proof seal (A) is attached to the spindle (D) but not secured in position, it can be easily deflected or displaced when the collet (C) is fastened to the spindle (D) and the spindle (D) rotates in relation with the collet (C). The deflected or displaced leak-proof seal (A) further causes the electrode tube (B) to deflect and fall into a flute (C1) of the collet (C). As illustrated in FIG. 9, when the diameter of the electrode tube (B) (e.g., not greater than 0.3 mm) is smaller than the pitch of the flute (C1), the electrode tube (B) can be easily caught and damaged by the flute (C1).

In the prior art, as described above, the collet (C) directly holds the electrode tube (B) in position and the leak-proof seal (A) functions only for leak-proof purposes without being secured in position. As a result, the electrode tube (B) in the collet (C) tends to partially deflect before being clamped by the collet (C). Of course, the locating means for the electrode tube (B) in the prior art is simple having the collet (C) to directly hold the electrode tube (B) in position. Therefore, the means to locate the electrode tube (B) in position pending further improvement.

### SUMMARY OF THE INVENTION

The primary purpose of the present invention is to provide a method and apparatus to precisely clamp an electrode tube particularly in smaller diameter in the center of the collet nut system used in the EDM drill equipment. To achieve the purpose, an elastic seal is provided for one end of the electrode tube to insert through to prevent fluid leaking from collet and nut. An insert placed in the collet is to concentrically accommodate and restrict the elastic seal while the electrode tube inserts through the centers of the insert and the elastic seal to help both the elastic seal and the electrode tube to be secured in position in relation to the collet to facilitate the collet to accurately hold the electrode tube.

A method for clamping an electrode tube in EDM drill equipment of the present invention is incorporated with an elastic seal and a collet. The upper end of the electrode tube is inserted through the elastic seal (e.g., rubber seal). The method comprises:
a. providing an insert that having a shape on one end to concentrically accommodate and restrict the elastic seal; and
b. disposing with through hole at the center of the insert; and
c. placing the insert into the collet; and
d. inserting the electrode tube through centers of the insert and the elastic seal; and
e. tightening the nut to the spindle to clamp the electrode tube and pass the EDM machining current from the spindle to electrical tube.

Furthermore, in step b, the center of the insert is disposed with a through hole corresponding to the outer diameter of the electrode tube. In step d, the through hole restricts the electrode tube to keep it staying in the center of the collet without swing, thus to be precisely held by the collet.

In step a, a guiding pipe further extends from the insert to receive the electrode tube; and in step c, the guiding pipe of the insert is inserted and secured in the collet.

A tapered guide hole is disposed at the lower end of the guiding pipe of the insert in step b; so in step d, the electrode tube can be easily inserted from the bottom of the collet through the guide hole and the centers of the insert and the elastic seal.

In step a, the outer wall of the guiding pipe of the insert is tapered with the outer diameter of the upper section slightly greater than that of the lower section; and in step c, the upper section of the guiding pipe of the insert is inserted and secured in the collet.

An apparatus for positioning an electrode tube in an EDM drill before EDM drilling process of the present invention is incorporated with an elastic seal, a collet and a nut.

The apparatus comprises an insert. The insert includes a retaining ring to concentrically accommodate and restrict the elastic seal. A through hole is disposed in the center of the insert with the insert being inserted in the collet. The diameter of the through hole corresponds to the outer diameter of the electrode tube to restrict the electrode tube so that the electrode tube is secured in the center of the collet without swing. A guiding pipe extends from the center of the insert for the electrode tube to insert therein, and the guiding pipe of the insert is inserted into the collet. The outer wall of the guiding pipe of the insert is tapered with the outer diameter of the upper section slightly greater than that of the lower section to facilitate the guiding pipe of the insert to be inserted and secured in the collet. A tapered guide hole is disposed at the lower end of the guiding pipe of the insert to interconnect with the through hole of the insert for the electrode tube to insert through easily.

Accordingly, the lower section of the elastic seal of the present invention is prevented from sinking into the collet to cause irregular deformation at a local part. The elastic seal is inserted into and concentrically restricted by the retaining ring of the insert. Therefore, the elastic seal is subject to only the vertical deformation without lateral deformation when packed, and it can easily hold against the inner wall of the spindle to produce excellent leak-proof purposes without demanding significant packing force. In other words, it takes fewer turns to fasten the nut of the collet to the spindle. That is, the elastic seal is not vulnerable to permanent deformation since it gives the best leak-proof purposes with only mild packing force that is far less than the fatigue strength of the elastic seal.

Furthermore, whereas the bottom of the retaining ring of the insert is located at a right angle with the outer wall of the guiding pipe and is placed on the top of the collet, once the guiding pipe is inserted into the upper end of the collet, the axis of the guiding pipe is overlapped with that of the collet for the electrode tube held in position at the center of the guiding pipe to naturally locate at the center of the collet.

As described above, the present invention provides the following advantages:
1. Durable for the elastic seal under normal use conditions: the bottom of the elastic seal is made flat and the lower section is restricted, the elastic seal is free of irregular deformation when subject to compression; meaning that the packing force required is only slightly greater than the pressure from the dielectric fluid and remains smaller than the fatigue strength of the elastic seal to achieve the leak-proof purposes. Lab test results show that the elastic seal withstands more than 100 times of clamp-unclamp cycle under fluid pressure and still stays in good condition.
2. Easy to locate the elastic seal and the electrode tube in the center: since the insert is inserted into the collet, the lower section of the elastic seal is restricted inside the insert, and the upper section of the electrode tube is inserted through the elastic seal; the electrode tube is also inserted through the guiding pipe of the insert. Relatively, both the elastic seal and the electrode tube are secured in the center of collet.
3. The electrode tube is naturally aligned at the axis of the collet: since the axis of the guiding pipe of the insert naturally overlaps with that of the collet, and the electrode tube is restricted by the through hole disposed at the center of the insert, the axis of the electrode tube overlaps with that of the collet.
4. The electrode tube is free of deformation: whereas it takes the balanced packing force slightly greater than the pressure of the dielectric fluid to achieve leak-proof results, the end of the electrode tube will not be damaged due to the excessively compression from the elastic seal.
5. The electrode tube is prevented from being deflected or crashed by collet: whereas the axis of the electrode tube naturally overlaps with that of the collet, the electric tube when clamped by the collet and nut is subject to stay in the center of collet to prevent from being caught and damaged by the flute of the collet.
6. The guide hole facilitates leading the electrode tube into the guiding pipe and the through hole to provide easy operation for the user to install the electrode tube while avoiding the possible bending or damage of the upper section of an electrode tube not greater than 0.3 mm in diameter.

### BRIEF DESCRIPTION OF THE DRAWINGS

FIG. 1 is a flow chart of a method of the present invention.

FIG. 2 is an exploded view of the device of first embodiment of the present invention.

FIG. 3 is a sectional view of the device of first embodiment of the present invention as assembled.

FIG. 4 is a bottom view showing the device of first embodiment of the present invention in clamped status.

FIG. 5 is an exploded view of the device of second embodiment of the present invention.

FIG. 6 is a sectional view of the device of second embodiment of the present invention as assembled.

FIG. 7 is a bottom view showing the device of second embodiment of the present invention in clamped status.

FIG. 8 is a sectional view of a prior art as assembled.

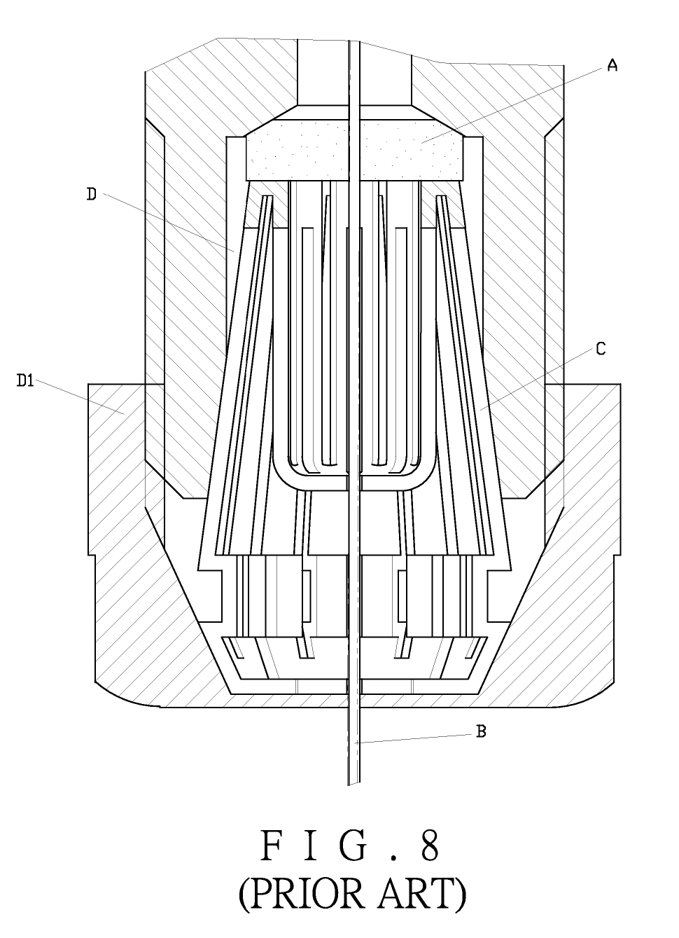

FIG. 9 is a bottom view showing the prior art in a false clamped status wherein the electrode tube is caught by flute of the collet.

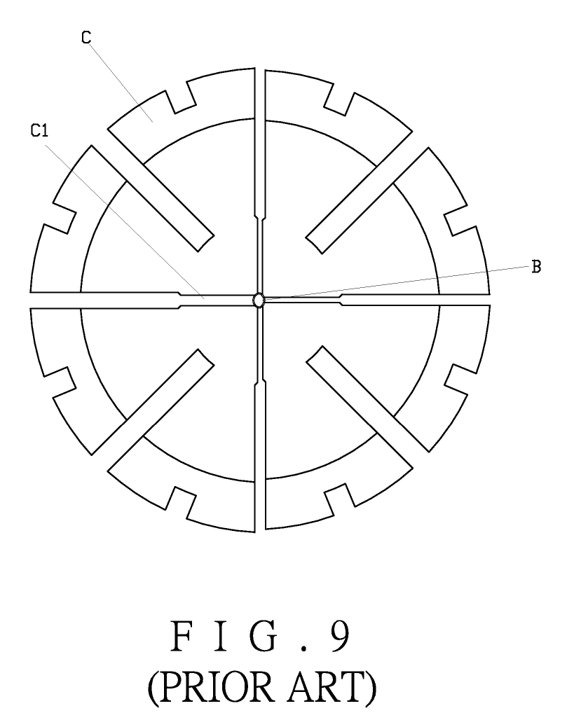

### DETAILED DESCRIPTION OF THE PREFERRED EMBODIMENTS

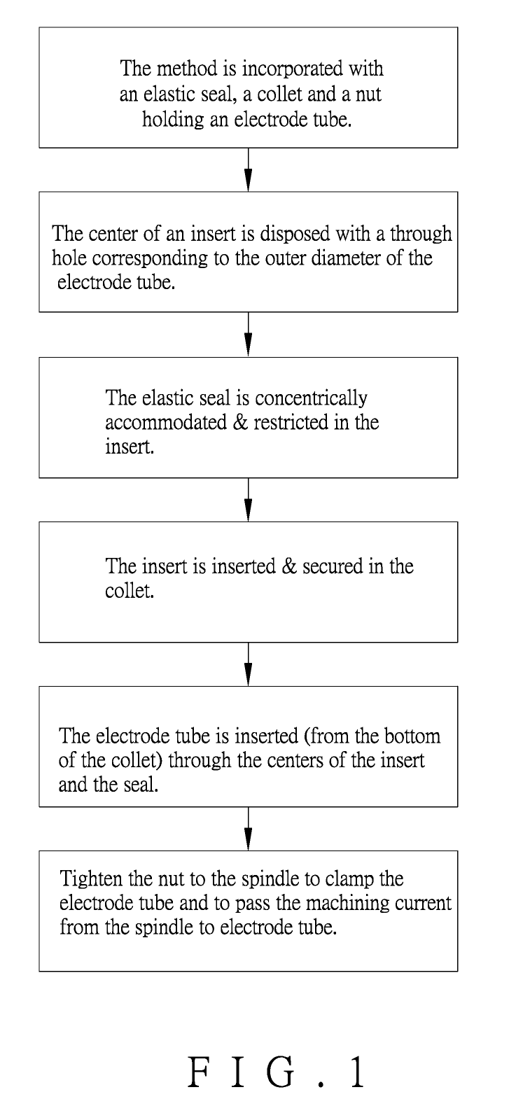

Referring to FIG. 1, a method for clamping an electrode tube in EDM drill equipment of the present invention is incorporated with an elastic seal (e.g., rubber seal) a collet, and a nut. The method comprises:
a. providing an insert that having a shape on one end to concentrically accommodate and restrict the elastic seal; and
b. disposing with through hole at the center of the insert;
c. placing the insert into the collet; and
d. inserting the electrode tube through centers of the insert and the elastic seal; and
e. tightening the nut to the spindle to clamp the electrode tube and pass the EDM machining current from the spindle to electrical tube.

Furthermore, in step a, the insert is provided with a guiding pipe for insertion of the electrode tube. In step c, the guiding pipe of the insert is inserted and secured in the upper end or the lower end of the collet.

In step a, a tapered guide hole is disposed at a lower end of the guiding pipe. So in step d, the electrode tube can be easily inserted from a lower end of the collet into the guide hole and through the insert and elastic seal.

In step a, the outer wall of the guiding pipe of the insert is tapered with the outer diameter of the upper section slightly greater than that of the lower section. In step c, the upper section of the guiding pipe of the insert is inserted and secured in the upper end or the lower end of the collet.

In step a, a couple of slots are provided at the lower portion of the guiding pipe, therefore in step e, the electrode tube is clamped through the insert instead of being clamped directly by the collet.

In the method of the present invention, the insert is to restrict the elastic seal from deformation and displacement, and the through hole at the center of the insert is to restrict the electrode tube from swing away from the center.

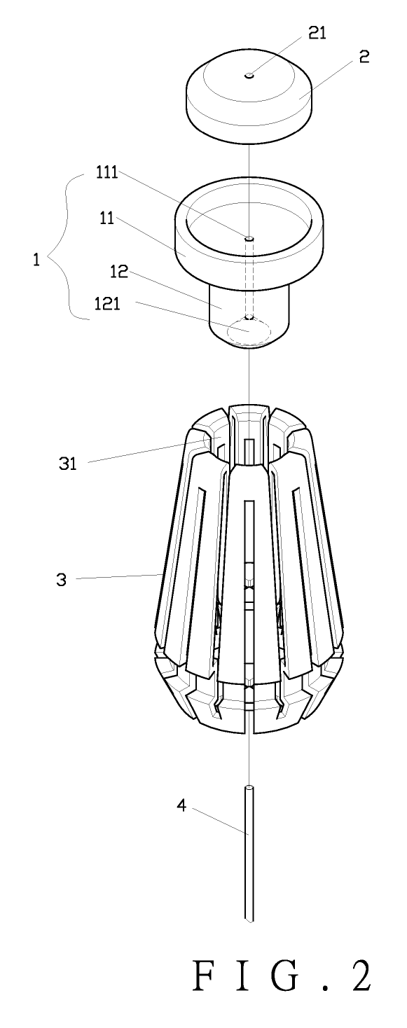

As illustrated in FIG. 2, a first embodiment of apparatus for clamping an electrode tube in EDM drill equipment of the present invention is incorporated with a collet (3) holding the electrode tube (4) and an elastic seal (2). The elastic seal (2) (e.g., rubber seal) is provided with a through hole (21) at the center of the elastic seal (2) to receive one end of an electrode tube (4) for leak-proof purposes.

The apparatus comprises an insert (1). The insert (1) comprises a retaining ring (11) to accommodate and restrict the lower section of the elastic seal (2). A through hole (111) corresponding to the outer diameter of the electrode tube (4) is provided at the center of the insert (1) for insertion of the electrode tube (4). The through hole (111) restricts the electrode tube (4) to be secured in the center of the collet (3) without swing away from the center too much. A guiding pipe (12) extends from the insert (1) and a tapered guide hole (121) is disposed at the lower end of the guiding pipe (12). The guide hole (121) is interconnected with the through hole (111) of the insert (1) for insertion of the electrode tube (4). The guiding pipe (12) of the insert (1) is inserted into a chamber (31) provided at the upper end of the collet (3). The outer wall of the guiding pipe (12) of the insert (1) is tapered with the outer diameter of the upper section slightly greater than that of the lower section so as to facilitate insertion of the guiding pipe (12) of the insert (1) into the chamber (31) at the upper end of the collet (3) to be secured therein.

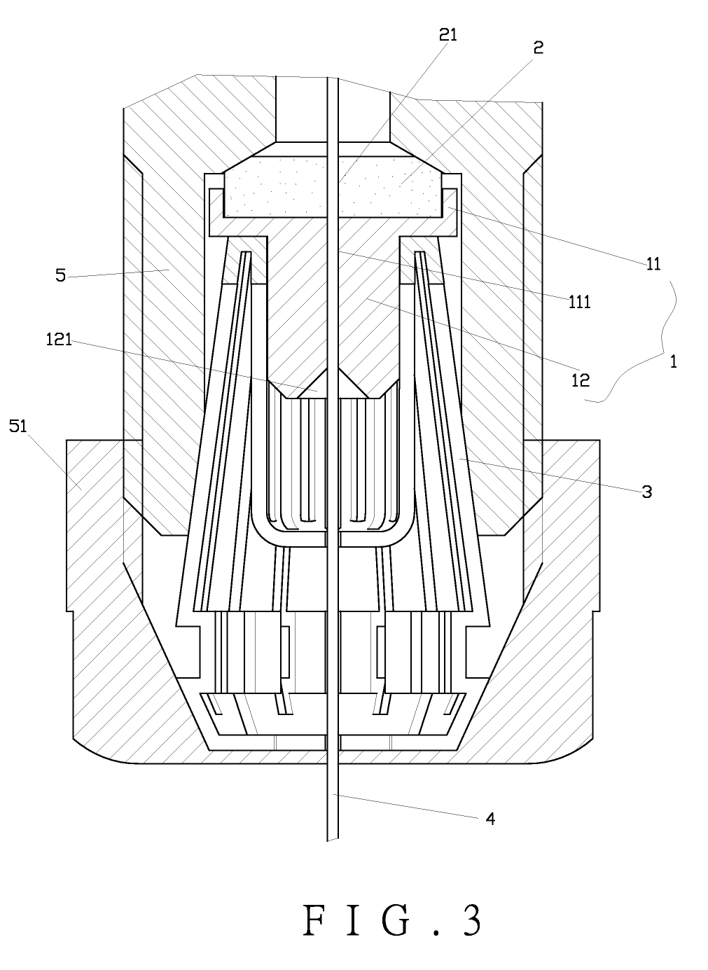

Now referring to FIG. 3, the lower section of the elastic seal (2) is contained and concentrically restricted in the retaining ring (11) of the insert (1). The guiding pipe (12) of the insert (1) is inserted into the chamber (31) of the collet (3). And the collet (3) is further contained between spindle (5) and a nut (51). The electrode tube (4) is inserted through the collet (3), the guide hole (121), the guiding pipe (12) and the through hole (111) with the upper section of the electrode tube (4) exposing from the through hole (21) of the elastic seal (2). Whereas the nut (51) from a spindle (5) and the spindle (5) are fastened to each other, the elastic seal (2) at the upper end of the collet (3) is compressed to pack against the spindle (5) for achieving leak-proof results. Accordingly, for being concentrically restricted by retaining ring (11), the elastic seal (2) is prevented from deflection with the electrode tube (4) while firmly compression made to the tilt section of the elastic seal (2) by the spindle. The configuration of the tilt section of the elastic seal (2) is made in relation to the inner wall of the spindle (5); therefore, it takes a packing force slightly greater than the pressure from dielectric fluid for the elastic seal (2) to provide leak-proof results. The insert (1) that accommodates and restricts the elastic seal (2) is secured in position in the upper end of the collet (3). The guide hole (121) facilitates insertion of the electrode tube (4) into the guiding pipe (12) and the through hole (111) for easy electrode installation by the operator and prevents the upper section of a small diameter electrode tube (4) (in diameter not greater than 0.3 mm) from being damaged before the electrode tube (4) is mounted into the elastic seal (2). The inner diameter of the through hole (111) corresponds to the outer diameter of the electrode tube (4) to prevent inserted electrode tube (4) creating too much swing while clamping the collet (3).

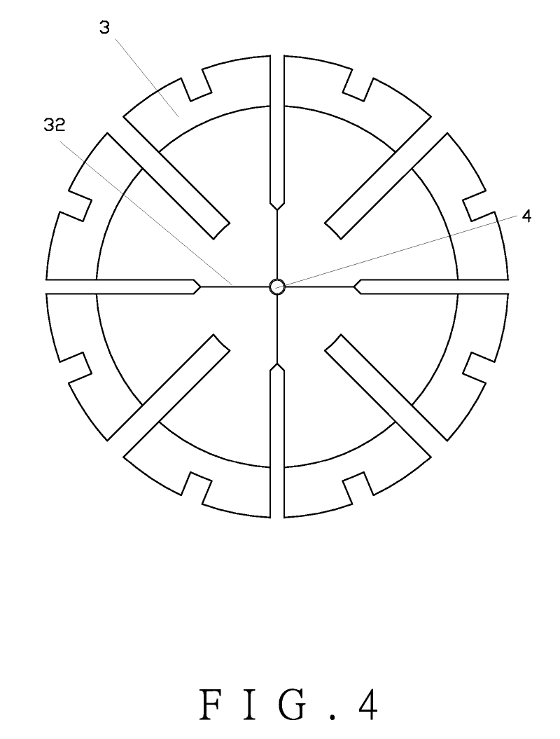

As illustrated in FIG. 4, the electrode tube (4) for being subject to restriction by both the elastic seal (2) and the insert (1) at the same time is held in position in relation to the collet (3). The electrode tube (4) for being restricted in the through hole (111) of the insert (1) will not be deflected to fall into a flute (32) of the collet (3). The axis of the electrode tube (4) naturally overlaps with that of the collet (3). Accordingly, the electrode tube (4) when clamped by the collet (3) is subject to the evenly distributed force to prevent from deflection.

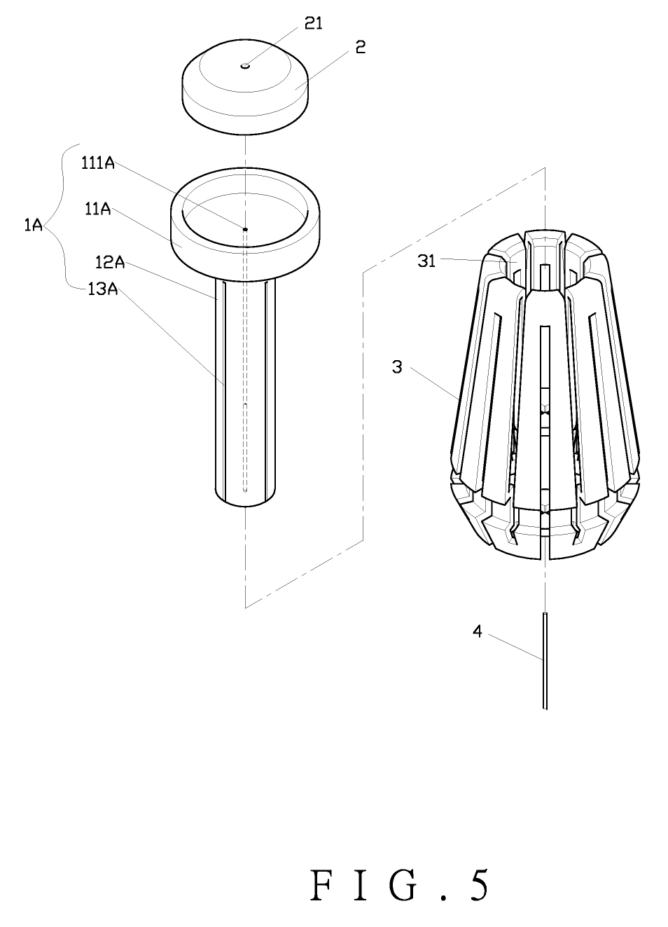

As illustrated in FIG. 5, a second embodiment of apparatus of the present invention is incorporated with a collet (3) holding the electrode tube (4) and an elastic seal (2). The second embodiment is used for clamping smaller diameter electrode tube (4) better than the first one. The elastic seal (2) (e.g., rubber seal) is provided with a through hole (21) at the center of the elastic seal (2) to receive one end of an electrode tube (4) for leak-proof purposes. The guiding pipe (12A) of the insert (1A), instead of collet (3), is used for clamping the electrode tube (4) when the guiding pipe (12A) is clamped by the collet (3). The insert (1A) comprises a guiding pipe (12A). A couple proper sized slots (13A) are provided at the lower portion of the guiding pipe (12A). Slots (13A) are choused big enough in order to firmly clamp the electrode tube (4) during drilling process. On the other hand these slots (13A) are not too big to catch and collapse the electrode tube (4).

The second embodiment of apparatus comprises an insert (1A). The insert (1A) comprises a retaining ring (11A) to concentrically accommodate and restrict the lower section of the elastic seal (2). A through hole (11A) corresponding to the outer diameter of the electrode tube (4) is provided at the center of the insert (1A) for insertion of the electrode tube (4). The through hole (11A) restricts the electrode tube (4) to be secured in the center of the collet (3) without swing. A guiding pipe (12A) extends from the insert (1A) and a tapered guide hole (121A) is disposed at the lower end of the guiding pipe (12A). The guide hole (121A) is interconnected with the through hole (11A) of the insert (1A) for insertion of the electrode tube (4). A couple proper sized slots (13A) are provided at the lower portion of the guiding pipe (12A). The guiding pipe (12A) of the insert (1A) is inserted into and secured by the collet (3).

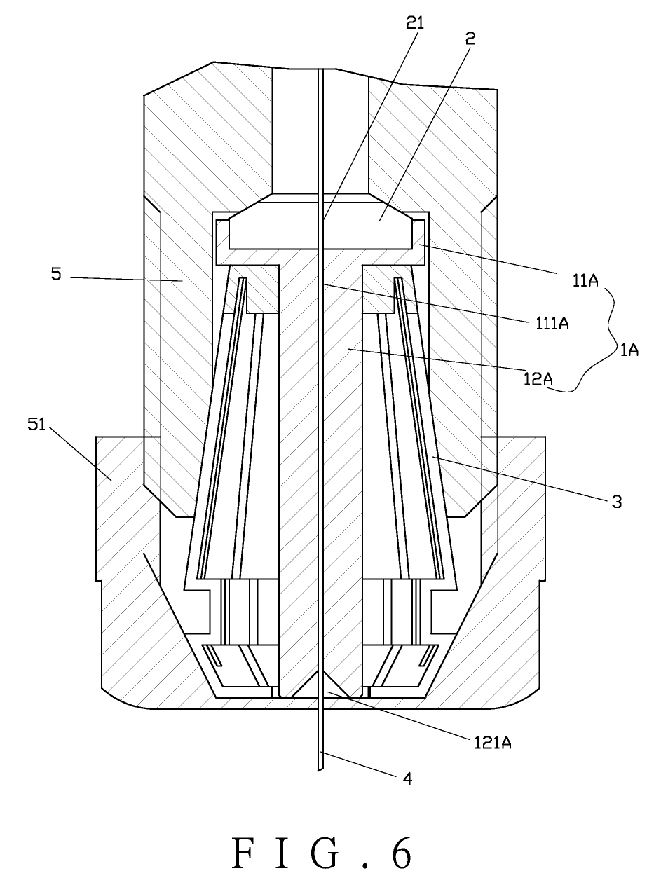

Now referring to FIG. 6, the lower section of the elastic seal (2A) is contained and restricted in the retaining ring (11A) of the insert (1A). The guiding pipe (12A) of the insert (1A) is inserted into the chamber (31) of the collet (3) and the lower end of the collet (3). And the collet (3) is further contained between a nut (51) and the spindle (5). The electrode tube (4) is inserted through, the collet (3), the guide hole (121A), the guiding pipe (12A) and the through hole (11A) with the upper section of the electrode tube (4) exposing from the through hole (21) of the elastic seal (2). Whereas the nut (51) from a spindle (5) and the spindle (5) are fastened to each other, the elastic seal (2) at the upper end of the collet (3) is compressed to pack against the spindle (5) for achieving leak-proof results. Accordingly, being concentrically restricted by retaining ring (11), the elastic seal (2) is prevented from deflection with the electrode tube (4) while firmly compression force applied to the tilt section of the elastic seal (2) by the spindle (5). The configuration of the tilt section of the elastic seal (2) is made in relation to the inner wall of the spindle (5); therefore, it takes a packing force slightly greater than the pressure from dielectric fluid for the elastic seal (2) to provide leak-proof results. The insert (1A) that accommodates and restricts the elastic seal (2) is secured in position in the collet (3). The guide hole (121A) facilitates insertion of the electrode tube (4) into the guiding pipe (12A) and the through hole (11A) for easy electrode tube installation by the operator and prevents the upper section of a small electrode tube (4) (in diameter not greater than 0.3 mm) from being damaged. The inner diameter of the through hole (11A) corresponds to the outer diameter of the electrode tube (4) to prevent inserted electrode tube (4) swing out of the center too much.

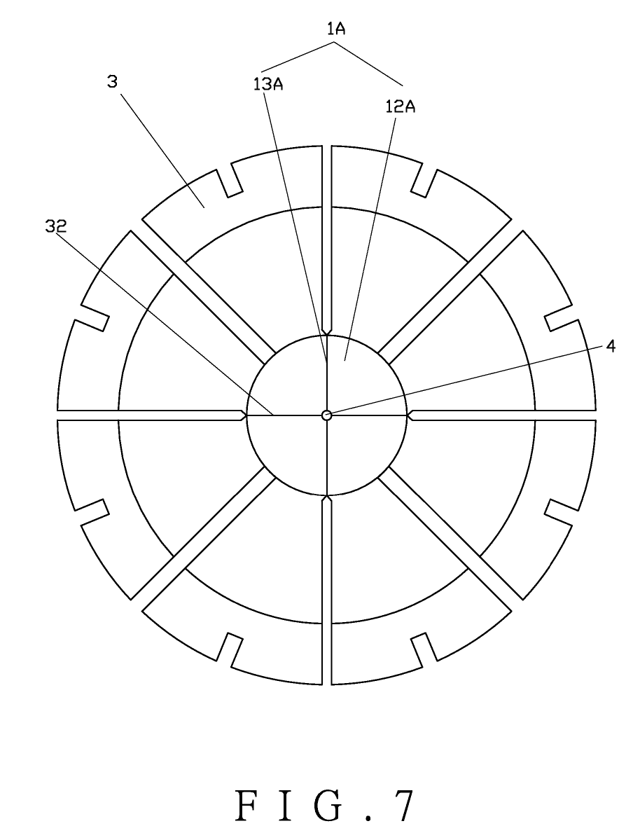

As illustrated in FIG. 7, the electrode tube (4) for being subject to restriction by both the elastic seal (2) and the insert (1A) at the same time is held in position in relation to the collet (3). The electrode tube (4) for being restricted in the through hole (11A) of the insert (1A) will not be deflected to fall into a flute (32) of the collet (3), or the slot of the guiding pipe (12A). The axis of the electrode tube (4) naturally overlaps with that of the collet (3). Accordingly, the electrode tube (4) when clamped by the guiding pipe (12A) in the collet (3) is subject to the evenly distributed force to prevent from deflection. Moreover, the guiding pipe (12A) of the insert (1A), instead of collet (3), is used for clamping the electrode tube (4). By selecting proper slot size, the slots (13A) are firmly clamping the electrode tube (4) during drilling process to conduct machining current well. Also, the chosen slots size helps the electrode tube (4) from caught and collapsed by the slot (13A) during clamping process.

What is claimed is:

1. A method for clamping an electrode tube in EDM drill equipment being incorporated with an elastic seal, a collet and a nut, comprising:
a. providing an insert that having a shape on one end to concentrically accommodate and restrict the elastic seal;
b. disposing with through hole at the center of the insert;
c. placing the insert into the collet;
d. inserting the electrode tube through centers of the insert and the elastic seal; and
e. tightening the nut to the spindle to clamp the electrode tube and passing the EDM machining current from the spindle to electrode tube.

2. The method for clamping an electrode tube in EDM drill equipment, as recited in claim 1, wherein a guiding pipe extends from the insert in step a, and the guiding pipe is inserted and secured in the collet in step c.

3. The method for clamping an electrode tube in EDM drill equipment, as recited in claim 2, wherein a tapered guide hole is disposed at a lower end of the guiding pipe in step a; the electrode tube is inserted from a lower end of the collet into the guide hole and through the insert and elastic seal in step d.

4. The method for clamping an electrode tube in EDM drill equipment, as recited in claim 2, wherein the guiding pipe has a tapered outer wall with the outer diameter of an upper section slightly greater than that of a lower section in step a; and an upper section of the guiding pipe is inserted and secured in the collet in step c.

5. The method for clamping an electrode tube in EDM drill equipment, as recited in claim 2, wherein couple slots are provided at the lower portion of the guiding pipe in step a; and the electrode tube is clamped through the insert instead of clamped directly by the collet.

6. An apparatus for clamping an electrode tube in EDM drill equipment being incorporated with an elastic seal, a collet and a nut, and characterized by:
the apparatus comprising an insert, the insert comprising a retaining ring on one end to concentrically accommodate and restrict the elastic seal, a through hole being disposed at the center of the insert, the insert being inserted and secured in the collet, the electrode tube is clamped by fastening the nut to the spindle.

7. The apparatus for clamping an electrode tube in EDM drill equipment, as recited in claim 6, wherein the through hole at the center of the insert has an inner diameter corresponding to an outer diameter of the electrode tube.

8. The apparatus for clamping an electrode tube in EDM drill equipment, as recited in claim 7, wherein a guiding pipe extends from the center of the insert.

9. The apparatus for clamping an electrode tube in EDM drill equipment, as recited in claim 8, wherein the guiding pipe has a tapered outer wall with the outer diameter of an upper section slightly greater than the outer diameter of a lower section.

10. The apparatus for clamping an electrode tube in EDM drill equipment, as recited in claim 8, wherein a tapered guide hole is disposed at a lower end of the guiding pipe of the insert, and the guide hole is interconnected with the through hole of the insert.

11. The apparatus for clamping an electrode tube in EDM drill equipment, as recited in claim 8, wherein couple proper sized slots are provided at the lower portion of the guiding pipe to clamp the electrode tube through the insert instead of clamping directly by the collet.
